(19) United States
(12) Patent Application Publication
(10) Pub. No.: US 2017/0300752 A1
(43) Pub. Date: Oct. 19, 2017

(54) METHOD AND SYSTEM FOR SUMMARIZING MULTIMEDIA CONTENT

(71) Applicant: YEN4KEN, INC., Princeton, NJ (US)

(72) Inventors: Arijit Biswas, Kolkata (IN); Harish Arsikere, Bangalore (IN); Pramod Sankar Kompalli, Hyderabad (IN); Kuldeep Yadav, Gurgaon (IN); Jagadeesh Chandra Bose Rantham Prabhakara, Chittoor (IN); Kovendhan Ponnavaikko, Chennai (IN); Om D. Deshmukh, Bangalore (IN); Mohana Prasad Sathya Moorthy, Chennai (IN)

(21) Appl. No.: 15/131,085

(22) Filed: Apr. 18, 2016

(51) Int. Cl. G06K 9/00; G06K 9/62; G06K 9/46; G11B 27/031; G09B 5/02

(52) U.S. Cl. CPC G06K 9/00718; G11B 27/031; G09B 5/02; G06K 9/4642; G06K 9/4671; G06K 9/6202

(57) ABSTRACT

A method and a system are provided for creating a summarized multimedia content. The method extracts one or more frames from a plurality of frames in a multimedia content based on a measure of area occupied by a text content in a portion of each of the plurality of frames. The method selects one or more sentences from an audio content associated with the multimedia content based on at least a weight associated with a plurality of words present in the audio content. The method extracts one or more audio segments from the audio content associated with the multimedia content based on one or more parameters associated with the audio content. The method creates the summarized multimedia content based on the one or more frames, the one or more sentences, and the one or more audio segments.

### TECHNICAL FIELD

The presently disclosed embodiments are related, in general, to multimedia content processing. More particularly, the presently disclosed embodiments are related to method and system for summarizing a multimedia content.

### BACKGROUND

Advancements in the field of education have led to the usage of Massive Open Online Courses (MOCCs) as one of the popular modes of learning. Educational organizations provide multimedia content in the form of video lectures, and/or audio lectures to students for learning. Typically, multimedia content covers a plurality of topics that are discussed over a duration of the multimedia content.

Usually the multimedia content such as educational multimedia content is of long duration in comparison to non-educational multimedia content. Thus, the memory/storage requirement of such multimedia content is high. Further, streaming/downloading such multimedia content may require appropriate network bandwidth/storage space for seamless playback of the multimedia content, which may be an issue for users/student/viewers that have limited network bandwidth/storage space.

Further limitations and disadvantages of conventional and traditional approaches will become apparent to those skilled in the art, through a comparison of described systems with some aspects of the present disclosure, as set forth in the remainder of the present application and with reference to the drawings.

### SUMMARY

According to embodiments illustrated herein, there may be provided a method for summarizing a multimedia content. The method may utilize one or more processors to extract one or more frames from a plurality of frames in a multimedia content based on a measure of area occupied by a text content in a portion of each of the plurality of frames. The method may select one or more sentences from an audio content associated with the multimedia content based on at least a weight associated with a plurality of words in the plurality of sentences present in the audio content. The method may extract one or more audio segments from the audio content associated with the multimedia content based on one or more parameters associated with the audio content. The method may further create the summarized multimedia content based on the one or more frames, the one or more sentences, and the one or more audio segments.

According to embodiments illustrated herein, there may be provided a system that comprises a multimedia content server configured to summarize a multimedia content. The multimedia content server may further comprise one or more processors configured to extract one or more frames from a plurality of frames in a multimedia content, based on a measure of area occupied by a text content in a portion of each of the plurality of frames. The multimedia content server may select one or more sentences from an audio content associated with the multimedia content based on at least a weight associated with a plurality of words in the plurality of sentences present in the audio content. The multimedia content server may extract one or more audio segments from the audio content associated with the multimedia content based on one or more parameters associated with the audio content. The multimedia content server may further create the summarized multimedia content based on the one or more frames, the one or more sentences, and the one or more audio segments.

According to embodiments illustrated herein, a non-transitory computer-readable storage medium having stored thereon, a set of computer-executable instructions for causing a computer comprising one or more processors to perform steps of extracting, one or more frames from a plurality of frames in a multimedia content, based on a measure of area occupied by a text content in a portion of each of the plurality of frames. The one or more processors may select one or more sentences from an audio content associated with the multimedia content based on at least a weight associated with a plurality of words in the plurality of sentences present in the audio content. The one or more processors may extract one or more audio segments from the audio content associated with the multimedia content based on one or more parameters associated with the audio content. The one or more processors may further create a summarized multimedia content based on the one or more frames, the one or more sentences, and the one or more audio segments.

### BRIEF DESCRIPTION OF DRAWINGS

The accompanying drawings illustrate the various embodiments of systems, methods, and other aspects of the disclosure. Any person with ordinary skill in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not limit the scope in any manner, wherein similar designations denote similar elements, and in which:

FIG. 1 is a block diagram that illustrates a system environment in which various embodiments of a method and a system may be implemented;

FIG. 2 is a block diagram that illustrates a multimedia content server configured to summarize the multimedia content in accordance with at least one embodiment;

FIG. 3 is a block diagram that illustrates an exemplary scenario to summarize an educational instructional video in accordance with at least one embodiment;

FIG. 4 is a flowchart that illustrates a method to summarize the multimedia content in accordance with at least one embodiment;

FIG. 5 illustrates an example user-interface presented on a user-computing device to display the summarized multimedia content in accordance with at least one embodiment.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes, as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Definitions: The following terms shall have, for the purposes of this application, the respective meanings set forth below.

A “multimedia content” refers to at least one of, but is not limited to, an audio content, a video content, a text content, an image, a slide deck, and/or an animation. In an embodiment, the multimedia content may be rendered through a media player such as a VLC Media Player, a Windows Media Player, an Adobe Flash Player, an Apple QuickTime Player, and the like, on a computing device. In an embodiment, the multimedia content may be downloaded or streamed from a multimedia content server to the computing device. In an alternate embodiment, the multimedia content may be stored on a storage device such as a Hard Disk Drive (HDD), a Compact Disk (CD) Drive, a Flash Drive, and the like, connected to (or inbuilt within) the computing device. In an embodiment, the multimedia content may correspond to a multimedia document that includes at least one of, but is not limited to, an audio content, a video content, a text content, an image, a slide deck, and/or an animation.

A “frame” may refer to an image that corresponds to a single picture or a still shot that is a part of a larger multimedia content (e.g., a video). A multimedia content is usually composed of a plurality of frames that are rendered, on a display device, in succession to produce what appears to be a seamless piece of the multimedia content. In an embodiment, the frame in the multimedia content may include text content. The text content corresponds to one or more keywords that are arranged in form of sentences. The sentences may have a meaningful interpretation. In an embodiment, the text content may be represented/presented/displayed in a predetermined area of the frame. In an embodiment, the predetermined area where the text content is displayed in the plurality of frames corresponds to at least one of a blackboard, a whiteboard, a paper, and/or a projection screen.

A “pixel” refers to an element of data that may be provided in any format, color space, or compression state that is associated with or readily convertible into data that can be associated with a small area or spot in an image that is printed or displayed. In an embodiment, a pixel is represented by bits where the number of bits in a pixel is indicative of the information associated with the pixel.

“Audio content” refers to an audio signal associated with a multimedia content. In an embodiment, the objects in the multimedia content may have generated the audio signal. Such audio signal has been referred to as the audio content. In an embodiment, the audio signal is a representation of a sound, typically as an electrical voltage. In an embodiment, the audio signals have frequencies in the audio frequency range of approximately 20 Hz to 20,000 Hz. In an alternate embodiment, the audio content may be referred to as audio transcript file that may be obtained based on the speech to text conversion of the audio signal.

A “weight” refers to an importance score that may be assigned to a parameter or a feature. In an embodiment, the weight may be deterministic of an importance of the parameter or the feature. In an alternate embodiment, the weight may refer to value that may be indicative of a similarity between two parameters or two features. For example, weight may be assigned to one or more sentences. The weight is indicative of a similarity between the one or more sentences.

“One or more parameters” refer to parameters associated with an audio content. In an embodiment, the one or more parameters comprise an intensity of a speaker in the audio content, a speaking rate of the speaker in the audio content, a prosodic pattern of the speaker in the audio content, an accent of the speaker in the audio content, and an emotion of the speaker in the audio content. For example, the intensity of the speaker in the audio content may correspond to a degree of stress input by the user on a particular keyword while explaining the content. Further, a speaking rate may correspond to a number of keywords spoken by a user within a pre-defined time interval. The accent of the speaker may correspond to a manner of pronunciation peculiar to a particular individual, location, or nation. The prosodic pattern refers to the patterns of rhythm and sound used by the instructor while explaining in the multimedia content. In an embodiment, the prosodic patterns may be utilized to identify human emotions and attitude.

“One or more audio segments” refers to a part of an audio content associated with a multimedia content that is extracted based on one or more parameters associated with the audio content.

A “summarized multimedia content” refers to a summary of a multimedia content that is created based on an input received from a user. In an embodiment, the summarized multimedia content may have a pre-defined storage size and a pre-defined playback duration.

A “first rank” refers to a value that is indicative of a degree of similarity between a pair of sentences from one or more sentences that have been extracted from the audio content. In an embodiment, the first rank may be determined using a first ranking method. In an embodiment, the first ranking method may correspond to determining a TF-IDF scores for the plurality of words in the sentence. The first ranking method further comprises determining the similarity between the pair of sentences based of the TF-IDF scores. The first rank is assigned to the plurality of sentences based on the similarity.

A “second rank” refers to a value that is assigned to each of one or more sentences based on one or more parameters associated with a portion of an audio content where the one or more sentences have been referred or have been recited in the multimedia content. For example, a sentence is extracted from the multimedia content, which has been recited in the multimedia content between timestamp 10 second and timestamp 11 second. The second rank is assigned to the sentence based on the one or more parameters associated with a portion of the audio content (of the multimedia content) between the timestamp 10 second and timestamp 11 second. In an embodiment, the method to determine the second rank has been referred to as the second rank method.

A “third rank” refers to a value that is associated with each of one or more sentences. In an embodiment, the third rank is assigned based on a first rank and a second rank. In an embodiment, the third rank may be indicative of a degree of liveliness and a degree of importance associated with each of the one or more sentences. The method of determining the third rank has been referred to as third rank method.

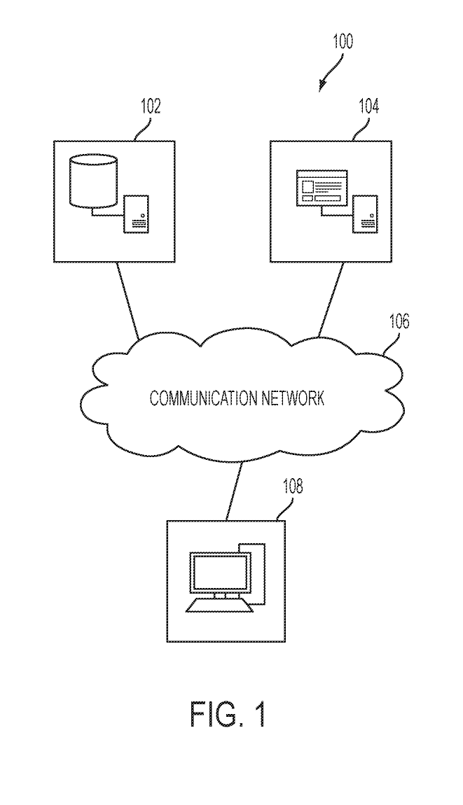

FIG. 1 is a block diagram that illustrates a system environment 100 in which various embodiments of a method and a system may be implemented. The system environment 100 may include a database server 102, a multimedia content server 104, a communication network 106, and a user-computing device 108. The database server 102, the multimedia content server 104, and the user-computing device 108 may be communicatively coupled with each other via the communication network 106. In an embodiment, the multimedia content server 104 may communicate with the database server 102 using one or more protocols such as, but are not limited to, Open Database Connectivity (ODBC) protocol and Java Database Connectivity (JDBC) protocol. In an embodiment, the user-computing device 108 may communicate with the multimedia content server 104 via the communication network 106.

In an embodiment, the database server 102 may refer to a computing device that may be configured to store multimedia content. In an embodiment, the database server 102 may include a special purpose operating system specifically configured to perform one or more database operations on the multimedia content. Examples of the one or more database operations may include, but are not limited to, Select, Insert, Update, and Delete. In an embodiment, the database server 102 may be further configured to index the multimedia content. In an embodiment, the database server 102 may include hardware and/or software that may be configured to perform the one or more database operations. In an embodiment, the database server 102 may be realized through various technologies such as, but not limited to, Microsoft® SQL Server, Oracle®, IBM DB2®, Microsoft Access®, PostgreSQL®, MySQL® and SQLite®, and the like.

In an embodiment, an entity may use a computing device to upload the multimedia content to the database server 102. Examples of the entity may include, but are not limited to, an educational institution, an online video streaming service provider, a student, and a professor. The database server 102 may be configured to receive a query from the multimedia content server 104 to obtain the multimedia content. In an embodiment, one or more querying languages may be used while creating the query. Examples of such querying languages include SQL, SPARQL, XQuery, XPath, LDAP, and the like. Thereafter, the database server 102 may be configured to transmit the multimedia content to the multimedia content server 104 for summarization, via the communication network 106.

A person with ordinary skill in the art will understand that the scope of the disclosure is not limited to the database server 102 as a separate entity. In an embodiment, the functionalities of the database server 102 may be integrated into the multimedia content server 104, and vice versa.

In an embodiment, the multimedia content server 104 may refer to a computing device or a software framework hosting an application or a software service. In an embodiment, the multimedia content server 104 may be implemented to execute procedures such as, but not limited to, programs, routines, or scripts stored in one or more memories for supporting the hosted application or the software service. In an embodiment, the hosted application or the software service may be configured to perform one or more predetermined operations. In an embodiment, the multimedia content server 104 may be configured to transmit the query to the database server 102 to retrieve the multimedia content. In an embodiment, the multimedia content server 104 may be configured to stream the multimedia content on the user-computing device 108 over the communication network 106. In an alternate embodiment, the multimedia content server 104 may be configured to play/render the multimedia content on a display device associated with the multimedia content server 104 through a media player such as a VLC Media Player, a Windows Media Player, an Adobe Flash Player, an Apple QuickTime Player, and the like. In such a scenario, the user-computing device 108 may access or control the playback of the multimedia content through a remote connection using one or more protocols such as remote desktop connection protocol, and PColP. The multimedia content server 104 may be realized through various types of application servers such as, but are not limited to, a Java application server, a .NET framework application server, a Base4 application server, a PHP framework application server, or any other application server framework.

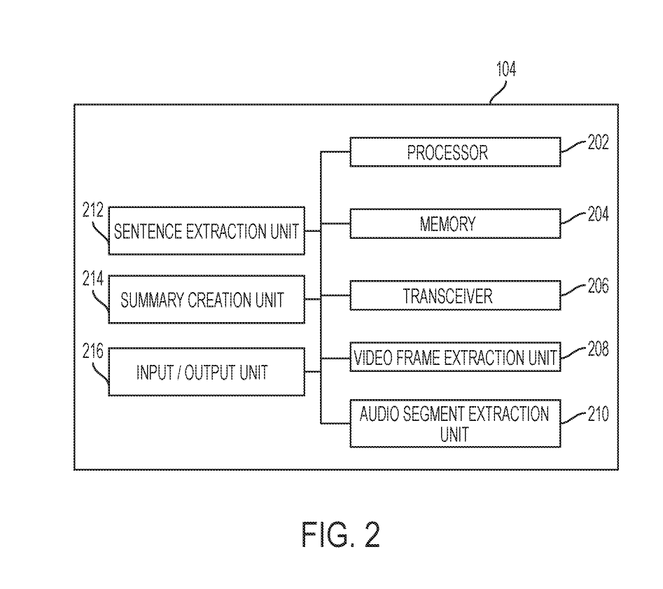

In an embodiment, the multimedia content server 104 may be configured to extract one or more frames from a plurality of frames in the multimedia content based on a measure of area occupied by a text content in a portion of each of the plurality of frames. The multimedia content server 104 may be configured to select one or more sentences from an audio content associated with the multimedia content based on at least a weight associated with each sentence of the one or more sentences. The multimedia content server 104 may be configured to assign a first rank, a second rank, and a third rank to each of the one or more sentences. Further, the multimedia content server 104 may be configured to extract one or more audio segments from the audio content associated with the multimedia content based on one or more parameters associated with the audio content. Further, the multimedia content server 104 may be configured to create a summarized multimedia content based on the one or more frames, the one or more sentences, and the one or more audio segments. In an embodiment, the one or more frames, the one or more audio segments, and the one or more sentences may be extracted based on a pre-defined playback duration, and a pre-defined storage size provided as an input by the user through the user-computing device 108. The operation of the multimedia content server 104 has been discussed later in conjunction with FIG. 2.

In an embodiment, the multimedia content server 104 may be configured to display a user interface on the user-computing device 108. Further, the multimedia content server 104 may be configured to stream the multimedia content on the user-computing device 108 through the user interface. In an embodiment, the multimedia content server 104 may be configured to display/playback/stream the summarized multimedia content through the user interface. The multimedia content server 104 may stream the summarized multimedia content on the user-computing device 108 through the user interface.

A person having ordinary skill in the art will appreciate that the scope of the disclosure is not limited to realizing the multimedia content server 104 and the user-computing device 108 as separate entities. In an embodiment, the multimedia content server 104 may be realized as an application program installed on and/or running on the user-computing device 108 without departing from the scope of the disclosure.

In an embodiment, the communication network 106 may correspond to a communication medium through which the database server 102, the multimedia content server 104, and the user-computing device 108 may communicate with each other. Such a communication may be performed in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 106 may include, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

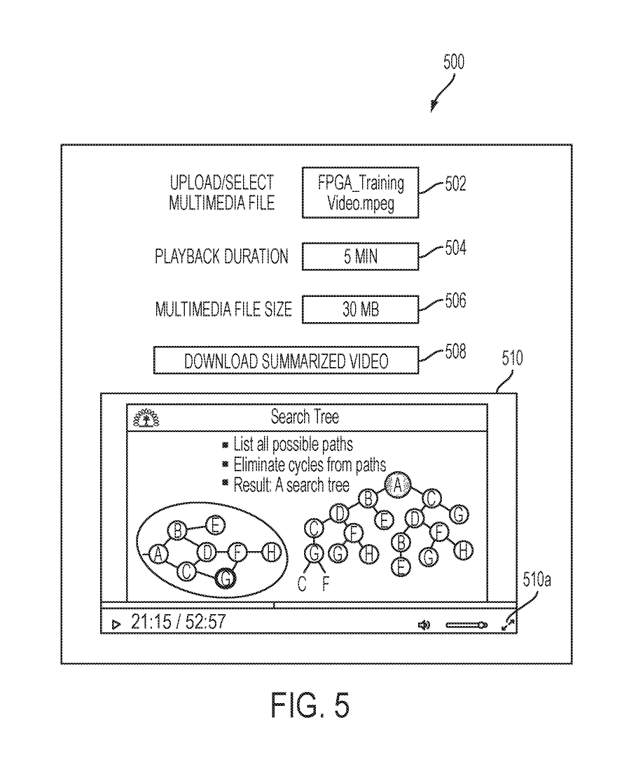

In an embodiment, the user-computing device 108 may refer to a computing device used by the entity. The user-computing device 108 may comprise one or more processors and one or more memories. The one or more memories may include a computer readable code that may be executable by the one or more processors to perform predetermined operations. In an embodiment, the user-computing device 108 may present the user-interface, received from the multimedia content server 104, to the user to display/playback/render the summarized multimedia content. In an embodiment, the user-computing device 108 may include hardware and/or software to display the summarized multimedia content. An example user-interface presented on the user-computing device 108 to view/download the summarized multimedia content has been explained in conjunction with FIG. 5. Examples of the user-computing device 108 may include, but are not limited to, a personal computer, a laptop, a personal digital assistant (PDA), a mobile device, a tablet, or any other computing device.

FIG. 2 is a block diagram that illustrates the multimedia content server 104 configured to summarize the multimedia content, in accordance with at least one embodiment. FIG. 2 is explained in conjunction with the elements from FIG. 1.

In an embodiment, the multimedia content server 104 includes a processor 202, a memory 204, a transceiver 206, a video frame extraction unit 208, an audio segment extraction unit 210, a sentence extraction unit 212, a summary creation unit 214, and an input/output unit 216. The processor 202 may be communicatively coupled to the memory 204, the transceiver 206, the video frame extraction unit 208, the audio segment extraction unit 210, the sentence extraction unit 212, the summary creation unit 214, and the input/output unit 216. The transceiver 206 may be communicatively coupled to the communication network 106.

The processor 202 comprises suitable logic, circuitry, interfaces, and/or code that may be configured to execute a set of instructions stored in the memory 204. The processor 202 may be implemented based on a number of processor technologies known in the art. The processor 202 may work in coordination with the video frame extraction unit 208, the audio segment extraction unit 210, the sentence extraction unit 212, the summary creation unit 214, and the input/output unit 216, to summarize the multimedia content. Examples of the processor 202 include, but not limited to, an X86-based processor, a Reduced Instruction Set Computing (RISC) processor, an Application-Specific Integrated Circuit (ASIC) processor, a Complex Instruction Set Computing (CISC) processor, and/or other processor.

The memory 204 comprises suitable logic, circuitry, interfaces, and/or code that may be configured to store the set of instructions, which are executed by the processor 202. In an embodiment, the memory 204 may be configured to store one or more programs, routines, or scripts that may be executed in coordination with the processor 202. The memory 204 may be implemented based on a Random Access Memory (RAM), a Read-Only Memory (ROM), a Hard Disk Drive (HDD), a storage server, and/or a Secure Digital (SD) card.

The transceiver 206 comprises suitable logic, circuitry, interfaces, and/or code that may be configured to receive the multimedia content from the database server 102, via the communication network 106. The transceiver 206 may be further configured to transmit the user interface to the user-computing device 108, via the communication network 106. Further, the transceiver 206 may be configured to stream the multimedia content to the user-computing device 108 over the communication network 106 using one or more known protocols. The transceiver 206 may implement one or more known technologies to support wired or wireless communication with the communication network 106. In an embodiment, the transceiver 206 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer.

The transceiver 206 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g, and/or IEEE 802.11n), voice over Internet Protocol (VoIP), Wi-MAX, a protocol for email, instant messaging, and/or Short Message Service (SMS).

The video frame extraction unit 208 comprises suitable logic, circuitry, interfaces, and/or code that may be configured to detect the plurality of frames in the multimedia content. In an embodiment, each of the plurality of frames may comprise a portion that may correspond to an area where text content is displayed. Further, the video frame extraction unit 208 may be configured to determine histogram of oriented gradients (HOG) features associated with each frame of the plurality of frames. In an embodiment, the video frame extraction unit 208 may utilize the HOG features to identify the portion in each of the plurality of frames. In an embodiment, the video frame extraction unit 208 may be configured to extract one or more frames from the plurality of frames based on the identification of the portion in each of the plurality of frames. In an embodiment, the video frame extraction unit 208 may be implemented as an Application-Specific Integrated Circuit (ASIC) microchip designed for a special application, such as to extract the one or more frames from the plurality of frames in the multimedia content.

The audio segment extraction unit 210 comprises suitable logic, circuitry, interfaces, and/or code that may be configured to extract an audio signal corresponding to the audio content associated with the multimedia content. Further the audio segment extraction unit 210 may generate an audio transcript file using one or more automatic speech recognition techniques on the audio signal. In an embodiment, the audio segment extraction unit 210 may store the audio transcript in the memory 204. Additionally, the audio segment extraction unit 210 may be configured to determine one or more parameters associated with the audio signal. Thereafter, based on the audio transcript file and the one or more parameters associated with the audio signal, the audio segment extraction unit 210 may extract one or more audio segments from the audio content. In an embodiment, the audio segment extraction unit 210 may be implemented as an Application-Specific Integrated Circuit (ASIC) microchip designed for a special application, such as to extract one or more audio segments from the audio content.

The sentence extraction unit 212 comprises suitable logic, circuitry, interfaces, and/or code that may be configured to select one or more sentences from a plurality of sentences in the audio transcript file. In an embodiment, the sentence extraction unit 212 may create a graph that comprises of a plurality of nodes and a plurality of edges. In an embodiment, each of the plurality of nodes correspond to a sentence from the plurality of sentences. In an embodiment, each of the plurality of edges is representative of a similarity between a pair of sentences from the plurality of sentences. The sentence extraction unit 212 may be configured to determine the similarity between each pair of sentences from the plurality of sentences, prior to placing edge between the sentences in the pair of sentences in the graph. In an embodiment, the sentence extraction unit 212 may be configured to assign the weight to each of the plurality of sentences. Further, the sentence extraction unit 212 may be configured to assign a first rank to each of the plurality of sentences based on the assigned weight. The sentence extraction unit 212 may be configured to assign a second rank and a third rank to each of the plurality of sentences. In an embodiment, the one or more sentences are selected based on the first rank, the second rank, and the third rank. In an embodiment, the sentence extraction unit 212 may be implemented as an Application-Specific Integrated Circuit (ASIC) microchip designed for a special application, such as to select the one or more sentences from the plurality of sentences in the audio transcript file.

The summary creation unit 214 comprises suitable logic, circuitry, interfaces, and/or code that may be configured to create the summarized multimedia content based on the extracted one or more frames, the selected one or more sentences, and the extracted one or more audio segments. In an embodiment, the summary creation unit 214 may be implemented as an Application-Specific Integrated Circuit (ASIC) microchip designed for a special application, such as to create the summarized multimedia content.

The input/output unit 216 comprises suitable logic, circuitry, interfaces, and/or code that may be configured to receive an input or transmit an output to the user-computing device 108. The input/output unit 216 comprises various input and output devices that are configured to communicate with the processor 202. Examples of the input devices include, but are not limited to, a keyboard, a mouse, a joystick, a touch screen, a microphone, a camera, and/or a docking station. Examples of the output devices include, but are not limited to, a display screen and/or a speaker.

In operation, the processor 202 works in coordination with the video frame extraction unit 208, the audio segment extraction unit 210, the sentence extraction unit 212, the summary creation unit 214, and the input/output unit 216 to create the summarized multimedia content. In an embodiment, the multimedia content may correspond to at least a video file. In an embodiment, the multimedia content may comprise one or more slides in a pre-defined order or a sequence. The presenter in the multimedia content may have described the one or more slides in accordance with the sequence or the pre-defined order.

In an embodiment, the processor 202 in conjunction with the transceiver 206 may receive a query from the user-computing device 108 that may include a request to create the summarized multimedia content of the multimedia content. In an embodiment, the query may, additionally, specify the pre-defined playback duration and the pre-defined storage size associated with the summarized multimedia content. In an embodiment, the pre-defined playback duration and the pre-defined storage size may be received as input from the user. Based on the received query, the processor 202 in conjunction with the transceiver 206 may be configured to retrieve the multimedia content from the database server 102. In an alternate embodiment, the multimedia content may be received from the user-computing device 108.

After extracting the multimedia content, the video frame extraction unit 208 may be configured to extract the plurality of frames in the multimedia content. In an embodiment, each of the plurality of frames may comprise the portion that may correspond to the area where the text content is displayed in the plurality of frames. In an embodiment, the area may correspond to at least one of a blackboard, a whiteboard, a paper, and/or a projection screen. In an embodiment, the video frame extraction unit 208 may be configured to detect the portion in each of the plurality of frames. In an embodiment, the video frame extraction unit 208 may be configured to determine HOG features in each of the plurality of frames. In an embodiment, video frame extraction unit 208 may utilize the HOG features to identify the portion in each of the plurality of frames by using a support vector machine.

After detection of the plurality of frames in the multimedia content that contain the portion, the video frame extraction unit 208 may be configured to determine the measure of area occupied by the text content in the portion in each of the plurality of frames based on a mean-shift segmentation technique. A person having ordinary skills in the art will understand that in the multimedia content the area occupied by the text content in each of the plurality of frames may differ. For example, in the multimedia content, an instructor writes/modifies the text content on a whiteboard. This process to write/modify the text content on the whiteboard is displayed across the plurality of frames. Therefore, in some of the frames of the plurality of frames, the whiteboard may not have any text content displayed and some of the frames of the plurality of frames, the white board may have the text content displayed. Further, the amount of the text content displayed on the white board may also vary in the plurality of frames. In another example the instructor in the multimedia content may start writing on an empty blackboard. As the playback of the multimedia content progresses, the instructor may progressively fill the blackboard. Thus, in an embodiment, the area occupied by the text content in the portion may increase. However, after a period of time, the instructor may erase the blackboard and hence the measure of area occupied by the text content may reduce to zero.

In order to determine the measure of area occupied by the text content in the portion, a number of pixels in portion representing the text content may be determined for each of the plurality of frames. In an embodiment, the video frame extraction unit 208 may apply one or more image processing techniques, such as a Sobel operator on each of the plurality of frames to determine the number of pixels representing the text content in the portion in each of the plurality of frames.

In an embodiment, based on the number of pixels representing the text content, the video frame extraction unit 208 may be configured to create a histogram representing the number of pixels representing the text content in each of the plurality of frames. Thereafter, in an embodiment, the video frame extraction unit 208 may define a window of pre-defined size on the histogram. In an embodiment, the pre-defined size of the histogram may be indicative of a predetermined number of frames of the plurality of frames. In an embodiment, for the predetermined number of frames encompassed by the pre-defined window, the video frame extraction unit 208 may be configured to determine a local maxima of the number of pixels representing the text content in each of the pre-defined number of frames. In an embodiment, the frame, with maximum number of pixels representing the text content, is selected from the predetermined number of frames in the window as the one or more frames.

In certain scenarios, due to camera movements, zooming and occlusion of the instructor, the text content in the portion of frame is not readable/interpretable. Such frames may be redundant and may be filtered out from the one or more frames. In an embodiment, the video frame extraction unit 208 may further remove one or more redundant frames from the one or more frames. In an embodiment, the video frame extraction unit 208 may identify the one or more redundant frames. In an embodiment, the one or more redundant frames are identified based on one or more image processing techniques such as Scale-Invariant Feature Transform (SIFT), and Fast Library for Approximate Nearest Neighbors (FLANN). Herein onwards the term one or more frames refers to the frames obtained after removing the one or more redundant frames.

In a scenario, where the user has provided an input that corresponds to the duration of the summarized multimedia content. The video frame extraction unit 208 may be configured to further filter the one or more frames such that number of frames may be less than or equal to the product of frame rate of the multimedia content and the duration of the summarized multimedia content (received from the user). For example, the user has provided an input that the summarized multimedia content should be of duration 1 minute and the frame rate of the multimedia content is 30 fps, the video frame extraction unit 208 may determine the count of the one or more frames as 1800 frames.

In order to filter the one or more frames such that the count of the one or more frames is in accordance with the determined count of frames, the video frame extraction unit 208 may remove the frames from the one or more frames that have repeated text content. To identify the repeated frames, the video frame extraction unit 208 may compare pixels of each frame in the one or more frames with the pixels of other frames. In an embodiment, the video frame extraction unit 208 may assign a pixel comparison score to each frame based on the comparison. Further, the video frame extraction unit 208 may compare the pixel comparison score with a predetermined threshold value. If the pixel comparison score is less than the predetermined threshold value, the video frame extraction unit 208 may consider the two frames as repeated frames. Further, the video frame extraction unit 208 may remove the two frames. In an embodiment, the video frame extraction unit 208 may remove the frame randomly. In an embodiment, after removing the repeated frame, the video frame extraction unit 208 may still maintain the timestamp associated with the removed frame. In an embodiment, by maintaining the timestamp of the repeated frame, the video frame extraction unit 208 may have the information about the duration for which the removed frame was displayed in the multimedia content. Hereinafter, the one or more frames are considered to be non-repetitive frames.

Concurrently, the audio segment extraction unit 210 may be configured to extract the audio signal from the received multimedia content. Further the audio segment extraction unit 210 may be configured to convert the audio signal into the audio transcript file. Example of the audio transcript file may correspond to a .srt file. In an embodiment, the audio segment extraction unit 210 may utilize ASR techniques to generate the audio transcript file from the audio signal. In an embodiment, the audio transcript file may comprise a plurality of sentences. In an embodiment, the audio segment extraction unit 210 may store the plurality of sentences in the memory 204.

In an embodiment, the sentence extraction unit 212 may be configured to create the graph that comprises the plurality of nodes and the plurality of edges using the plurality of sentences stored in the memory 204. In an embodiment, each of the plurality of nodes may correspond to each of the plurality of sentences and each of the plurality of edges may be indicative a similarity between the plurality of sentences. In an embodiment, the sentence extraction unit 212 may further assign a weight to each of the plurality of edges. In an embodiment, the weight may be indicative of a measure of similarity between the plurality of sentences. Thus, the graph may be a weighted graph.

In an embodiment, to assign the weight to each of the plurality of edges, the sentence extraction unit 212 may assign weightage to a plurality of words in the plurality of sentences. In an embodiment, the sentence extraction unit 212 may determine term frequency (TF) and inverse document frequency (IDF) may be utilized to assign the weights to each of the plurality of words. In an embodiment, TF-IDF weights may be assigned to each of the plurality of words in accordance with equation 1.

TF*IDF(w in D)=c(w)*log(Nd/d(w)) (1)

where
‘w’ corresponds to a word from the plurality of words in the plurality of sentences;
c(w) corresponds to a number of occurrences of the word w in document D, where D corresponds to the audio transcript file;
Nd corresponds to a total number of documents; and
d(w) corresponds to the number of documents that contain the word ‘w’.
   In an embodiment, the plurality of words that may occur in most of the documents have TF*IDF weights close to zero. The TF*IDF weights may be an indicator of the importance of the word in the audio transcript file.

After determining the weight associated with each of the plurality of words in the plurality of sentences, the sentence extraction unit 212 may be configured to determine the similarity between the plurality of sentences based on the weight determined for the plurality of words. In order to determine the similarity between the plurality of sentences, the sentence extraction unit 212 may utilize the bag of words technique. In the bag of words technique, each sentence may be represented as an N-dimensional vector, where N is the number of possible words in the target language. For each word that occurs in a sentence, the value of corresponding dimension in the N-dimensional vector is the number of occurrence of the word in the sentence times the IDF value of the word. In an embodiment, the similarity between two sentences, such as sentence 1 (s1) and sentence (s2) may be determined in accordance with equation 2.

SIM(s1, s2)=(Σ_{w}t_{1w}*t_{2w})/((Σt₁ᵢ̂2)̂0.5*(Σt₂ᵢ̂2)̂0.5) (2)

where
s1, and s2 are the sentences; and
tiw is the TF*IDF weight of the word ‘w’ in sentence si.

Once the similarity between the plurality of sentences comprising the plurality of words is determined, the audio transcript file may be represented by a cosine similarity matrix. In an embodiment, the columns and the rows in the cosine similarity matrix corresponds to the sentences in the audio transcript file. Further, an index of the cosine similarity matrix corresponds to a pair of sentences from the plurality of sentences. In an embodiment, the value at the index corresponds to the similarity score between the sentences in the pair of sentences represented by the index. Thereafter, the sentence extraction unit 212 may assign weights to each of the plurality of edges in the graph. Based on the weight assigned to the plurality of sentences, the sentence extraction unit 212 may be configured to assign a first rank to a sentence from the plurality of sentences. In an embodiment, the first rank may correspond to the measure of similarity of a sentence with respect to other sentences. In an embodiment, the first rank of each sentence corresponds to a number of edges from each node (sentence) to the remaining nodes in the undirected un-weighted graph. The first rank of a sentence is indicative of how many sentences may be similar to the sentence in the audio transcript file. The sentence extraction unit 212 may be configured to select one or more sentences from the plurality of sentences based on the first rank. In an embodiment, sentences having similar meaning are assigned a lower first rank as compared to the sentences that cover the various concepts discussed in the multimedia content. Thus, similar sentences are discarded and the one or more sentences that encompass the various topics discussed in the multimedia content are selected for creating the summarized multimedia content. In an alternate embodiment, pre-defined threshold associated with the first rank may be received as input from the user. Thus, one or more sentences that have a first rank higher than the pre-defined threshold may be selected for creation of the summarized multimedia content.

After selection of the one or more sentences from the plurality of sentences, the audio segment extraction unit 210 may be configured to determine the one or more parameters associated with the audio content of the multimedia content. In an embodiment, the one or more parameters may comprise an intensity of a speaker in the audio content, a speaking rate of the speaker in the audio content, a prosodic pattern of the speaker in the audio content, an accent of the speaker in the audio content, and an emotion of the speaker in the audio content. Based on the one or more parameters, the audio segment extraction unit 210 may be configured to extract the one or more audio segments from the audio content associated with the multimedia content based on one or more parameters associated with the audio content. Further, the audio segment extraction unit 210 may be configured to determine sentence boundaries based on the silence duration, a pitch, an intensity and other prosodic features associated with the audio content. In an alternate embodiment, the sentence boundaries may be determined based on the audio transcript file. In such an embodiment, the sentence boundaries may be determined by aligning (e.g., forced alignment) the extracted one or more audio segments.

After determining the sentence boundaries, the audio segment extraction unit 210 may be configured to assign the second rank to each of the one or more sentences. In an embodiment, the second rank may be indicative of an audio saliency of each of the one or more sentences. The audio segment extraction unit 210 may be configured to determine the second rank based on a sentence stress and an emotion or liveliness associated with each sentence from the one or more sentence. In an embodiment, a user may stress on a sentence from the one or more sentences. The stress on the sentence may be indicative of importance of the sentence in a context of a given topic. In an embodiment, one or more parameters such as speaking rate, syllable duration, and intensity may be utilized to determine whether the user has stressed on the sentence from the one or more sentences.

Further, lively or emotionally rich sentences from the one or more sentences may make the summarized multimedia content more interesting as compared to the one or more sentences that have a flat sound associated with them. In an embodiment, a degree of liveliness associated with each of the one or more sentences may be estimated based on pitch modulation features, intensity modulation features, and voice quality parameters. For example, the voice quality parameters may include a harmonic to noise ratio and a spectral tilt. Thus, the audio segment extraction unit 210 may be configured to assign the second rank based on the audio saliency of each of the one or more sentences determined using the sentence stress and the degree of liveliness. In an embodiment, if the selected one or more sentences have a same first rank then the one or more sentences that have a higher degree of liveliness (higher second rank) may be selected for creating the summarized multimedia content based on the second rank. Based on the first rank and the second rank, the audio segment extraction unit 210 may be configured to assign the third rank to each of the one or more sentences. In an embodiment, the third rank may be indicative of a high degree of liveliness and a high degree of importance associated with each of the one or more sentences. In an embodiment, Maximal Marginal Relevance (MMR) approach may be utilized to assign the third rank to each of the one or more sentences. In an embodiment, the third rank for each of the one or more sentences may be calculated in accordance with the equation 3.

MMR(si)=×SIM(si, D)−(1−c)×SIM(si, SUMM) (3)

where
si represents the sentence;
D represents the audio transcript file;
c represents a constant parameter;
SUMM represents the selected one or more sentences that will be included in the summarized multimedia content;

SIM (si, D) represents a number of edges from node si to other nodes in the audio transcript file; and
SIM (si, SUMM) represents a number of edges from sentence si to the nodes (sentences) belonging to the summarized multimedia content.

MMR measures relevancy and novelty separately and then uses a linear combination of the both to generate the third rank. In an embodiment, the third rank may be computed iteratively for each of the one or more sentences to create the summarized multimedia content until the pre-defined storage size, and the pre-defined playback duration are met. In an embodiment, the one or more sentences to be included in the summarized multimedia content are selected based on a greedy selection from the plurality of sentences until the pre-defined storage size and the pre-defined playback duration are satisfied. The one or more sentences that have the third rank higher than a pre-defined threshold may be selected to create the summarized multimedia content. Thus, the one or more sentences that have the third rank higher than the pre-defined threshold may indicate that the one or more sentences cover/encompass the important concepts in the multimedia content. The summary creation unit 214 may be configured to create the summarized multimedia content by utilizing an optimization framework on each of the one or more frames, the one or more sentences with the third rank greater than the pre-defined threshold, and the one or more audio segments. In an embodiment, the summarized multimedia content may be created such that it satisfies the pre-defined playback duration and the pre-defined storage size.

A person having ordinary skills in the art will understand that the scope of the disclosure is not limited to assigning the first rank prior to the assigning the second rank. In an embodiment, the second rank may be assigned first followed by the first rank. In such a scenario, the second rank is assigned to the plurality of sentences. Thereafter, the one or more sentences are selected based on a comparison of the second rank with a predefined threshold. For the one or more sentences, the first rank is determined based on the TF-IDF score assigned to the plurality of words in the one or more sentences.

A person skilled in the art will understand that the scope of the disclosure should not be limited to creating the summarized multimedia content based on the aforementioned factors and using the aforementioned techniques. Further, the examples provided in supra are for illustrative purposes and should not be construed to limit the scope of the disclosure.

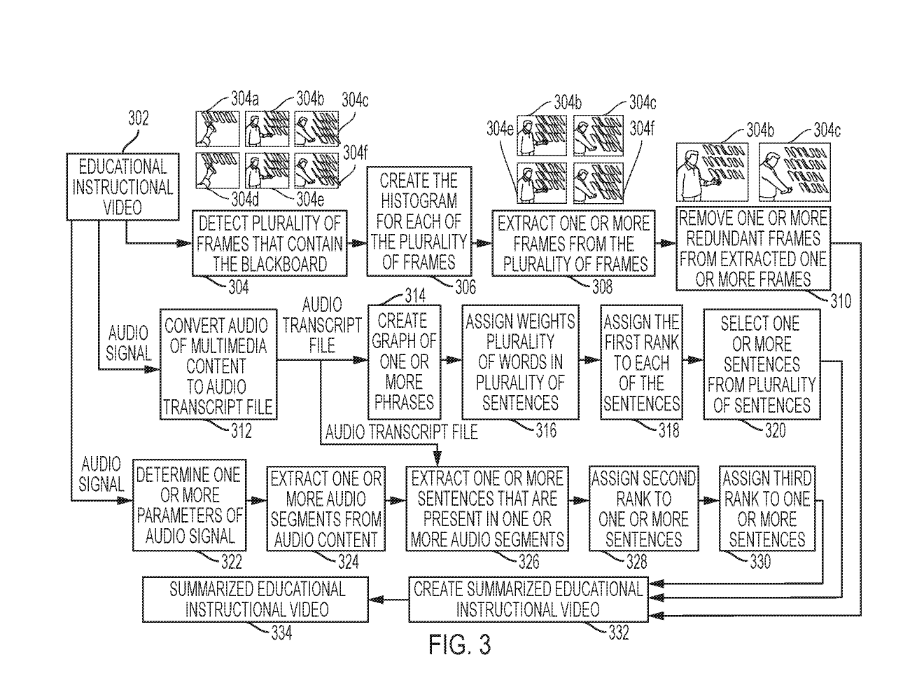

FIG. 3 is a block diagram that illustrates an exemplary scenario to create a summarized video of an educational instructional video, in accordance with at least one embodiment. FIG. 3 is described in conjunction with FIG. 1 and FIG. 2.

With reference to FIG. 3, a user may request the multimedia content server 104 to create a summarized video associated with an educational instructional video 302. In an embodiment, the playback duration of the educational instructional video 302 may be 45 minutes and the storage size may be 300 MB. The user may further specify that the summarized video should have a playback duration of 5 minutes and a storage size should be 2 MB. Based on the received request, the multimedia content server 104 may retrieve the educational instructional video 302 from the database server 102. In an alternate embodiment, the user may transmit the educational instructional video 302 to the multimedia content server 104 along with the request. In an embodiment, educational instructional video 302 may comprise of a plurality of frames that include the blackboard. The instructor in the education instructional video 302 may write text content on the blackboard.

At block 304, the video frame extraction unit 208 may be configured to detect the plurality of frames that contain the blackboard. For example, the frames 304a, 304b, 304c, 304d, 304e, and 304f may be referred to as frames that contain the blackboard. Further, at block 306 the video frame extraction unit 208 may create the histogram for each of the plurality of frames to detect frames that have a maximum measure of text content on the blackboard. At block 308, based on the measure of text content in the plurality of frames, the video frame extraction unit 208 may be configured to extract one or more frames from the plurality of frames based on the measure of text content on the blackboard. For example, the extracted one or more frames may be the frames denoted by 304b, 304c, 304e, and 304f. However, the extracted one or more frames may contain redundant text content due to similar content in the extracted one or more frames. For example, there may be redundancy in the extracted one or more frames because the instructor may occlude one or more portions of the blackboard. At block 310, one or more redundant frames may be removed from the extracted one or more frames. For example, the extracted frames 304b and 304c may contain redundant text content. Thus, the frames 304b and 304c may be removed.

The audio segment extraction unit 210 may be configured to extract an audio signal from the educational instructional video 302. At block 312, the audio segment extraction unit 210 may be configured to convert the audio signal into an audio transcript file. At block 314, the sentence extraction unit 212 may be configured to create the graph that comprises a plurality of nodes. In an embodiment, each of the plurality of nodes may correspond to each of the plurality of sentences in the audio content and each of the plurality of edges may correspond to a similarity between the plurality of sentences. At block 316, the sentence extraction unit 212 may be configured to assign the weights to each of the plurality of words in the plurality of sentences in accordance with equation 1. At block 318, the sentence extraction unit 212 may be configured to assign the first rank to each of the sentences based on the weight assigned to each of the plurality of words in the plurality of sentences in accordance with the equation 2. In an embodiment, the first rank may correspond to the measure of similarity of a sentence with respect to other sentences in the audio transcript file.

At block 320, the sentence extraction unit 212 may be configured to select one or more sentences from the plurality of sentences (plurality of sentences in the audio transcript file) based on the first rank. For example, the sentence extraction unit 212 may select the sentences 314a and 314c for creating the summarized educational instructional video 334. At block 322, the audio segment extraction unit 210 may be configured to determine one or more parameters associated with the audio content of the educational instructional video 302. In an embodiment, the one or more parameters may comprise an intensity of a speaker in the audio content, a speaking rate of the speaker in the audio content, a prosodic pattern of the speaker in the audio content, an accent of the speaker in the audio content, and an emotion of the speaker in the audio content.

At block 324, the audio segment extraction unit 210 may be configured to extract one or more audio segments from the audio content associated with the educational instructional video 302 based on the one or more parameters. Further, at block 326, based on the audio transcript file the audio segment extraction unit 210 may be configured to extract one or more sentences that are present in the one or more audio segments. At block 328, the audio segment extraction unit 210 may be configured to assign a second rank to each of the one or more sentences that are present in the one or more audio segments based on the one or more parameters. At block 330, the audio segment extraction unit 210 may be configured to assign the third rank to each of the one or more sentences in accordance with equation 3. In an embodiment, the third rank may be indicative of a high degree of liveliness and a high degree of importance associated with each of the one or more sentences.

At block 332, summary creation unit 214 may be configured to create the summarized educational instructional video denoted by 334 by iteratively computing the third rank for each of the one or more sentences until the pre-defined storage size, and the pre-defined playback duration are met. The one or more sentences that have the third rank higher than a pre-defined threshold may be selected to create the summarized educational instructional video denoted by 334. The summary creation unit 214 may be configured to create the summarized educational instructional video denoted by 334 by utilizing an optimization framework on each of the one or more frames, the one or more sentences with the third rank greater than the pre-defined threshold, and the one or more audio segments. In an embodiment, the summarized educational instructional video denoted by 334 may be created such that it satisfies the pre-defined playback duration and the pre-defined storage size.

A person skilled in the art will understand that the scope of the disclosure should not be limited to creating the summarized educational instructional video denoted by 334 based on the aforementioned factors and using the aforementioned techniques. Further, the examples provided in supra are for illustrative purposes and should not be construed to limit the scope of the disclosure.

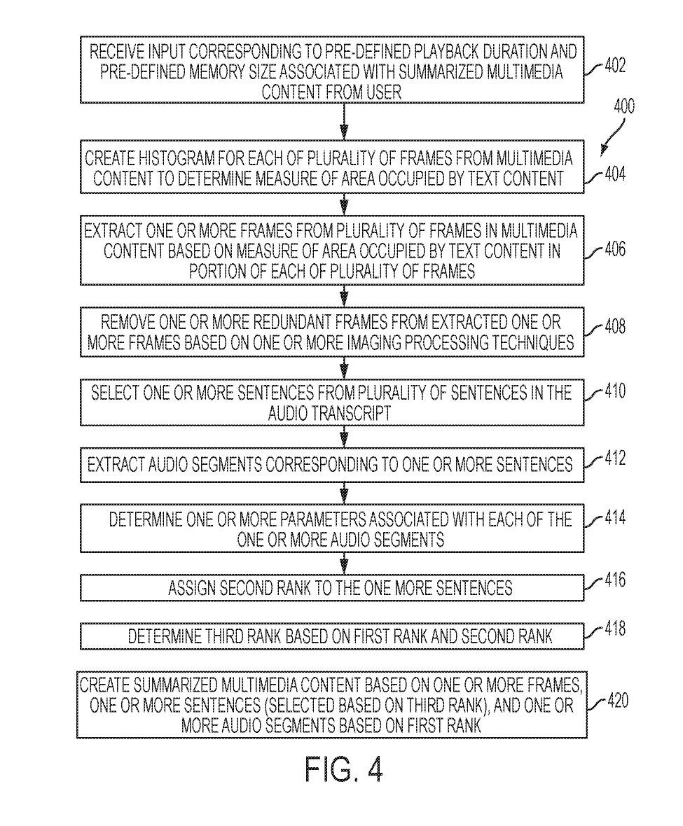

FIG. 4 is a flowchart 400 that illustrates a method to summarize the multimedia content, in accordance with at least one embodiment. The flowchart 400 is described in conjunction with FIG. 1 and FIG. 2.

At step 402, the multimedia content server 104 may receive an input corresponding to the pre-defined playback duration, and the pre-defined storage size associated with the summarized multimedia content from the user. At step 404, the multimedia content server 104 may create the histogram for each of the plurality of frames from the multimedia content to determine the measure of area occupied by the text content. At step 406, the multimedia content server 104 may extract the one or more frames from the plurality of frames in the multimedia content based on the measure of area occupied by the text content in the portion of each of the plurality of frames. At step 408, the multimedia content server 104 may remove the one or more redundant frames from the extracted one or more frames based on the one or more image processing techniques. A step 410, the one or more sentences are selected from the plurality of sentences in the audio transcript based on the first rank assigned to each of the plurality of sentences. In an embodiment, the first rank is assigned based on TF-IDF score assigned to the plurality of words in the plurality of sentences. At step 412, the multimedia content server 104 may extract the one or more audio segments from the audio content corresponding to the one or more sentences. At step 414, the one or more parameters associated with the one or more audio segments are determined. At step 416, the second rank is assigned to the one or more sentences based on the one or more parameters. At step 418, the third rank is assigned to the one or more sentences based on the second rank and the first rank. At step 420, the multimedia content server 104 may create the summarized multimedia content based on the one or more frames, the one or more sentences, and the one or more audio segments.

FIG. 5 illustrates an example user-interface 500 presented on the user-computing device 108 to display the summary of the multimedia content, in accordance with at least one embodiment.

The user-interface 500 displays a first input box 502. The user may select/upload the multimedia content that the user wants to summarize using the first input box 502. For example, the multimedia content to be summarized has the file name ‘FPGA_Training Video’. Further, a second input box 504 may be displayed that may be utilized by the user to specify the playback duration of the summarized multimedia content. For example, the playback duration entered by the user is 5 minutes. Further, a third input box 506 may be utilized by the user to specify a multimedia file size of the summarized multimedia content. For example, the user may enter the ‘30 MB’ as the multimedia file size. Further, a control button 508 may be displayed on the user-computing device 108. After selecting/uploading the multimedia content using the first input box 502, the user may input the playback duration and the multimedia file size associated with the summarized multimedia content using the second input box 504 and third input box 506, respectively, and then click on the control button 508. After the user clicks on the control button 508, the user may be able to download the summarized multimedia content that satisfies the playback duration and the multimedia file size as specified by the user. In an alternate embodiment, the user may view the summarized multimedia content within a first display area 510 of the user-computing device 108. Further, the user may navigate through the summarized multimedia content using playback controls 510a displayed on the user-computing device 108.

A person skilled in the art will understand that the user-interface 500 is described herein for illustrative purposes and should not be construed to limit the scope of the disclosure.

Various embodiments of the disclosure provide a non-transitory computer readable medium and/or storage medium, and/or a non-transitory machine-readable medium and/or storage medium having stored thereon, a machine code and/or a computer program having at least one code section executable by a machine and/or a computer to summarize the multimedia content. The at least one code section in an multimedia content server 104 causes the machine and/or computer comprising one or more processors to perform the steps, which comprises extracting one or more frames from a plurality of frames in a multimedia content, based on a measure of area occupied by a text content in a portion of each of the plurality of frames. The one or more processors may further select one or more sentences from an audio content associated with the multimedia content based on at least a weight associated with each sentence of the one or more sentences. The one or more processors may further extract one or more audio segments from the audio content associated with the multimedia content based on one or more parameters associated with the audio content. The one or more processors may further create the summarized multimedia content based on the one or more frames, the one or more sentences, and the one or more audio segments.

Various embodiments of the disclosure encompass numerous advantages including methods and systems for segmenting the multimedia content. In an embodiment, the methods and systems may be utilized to create the summary associated with the multimedia content. The methods and systems enables the user to view/download a summarized multimedia content such that the playback duration and the memory required by is less. Thus, the user having less network bandwidth and with less time availability will be able to view semantically important content from the multimedia content while viewing the summarized multimedia content. The method disclosed herein extracts audio and textual cues from the multimedia content and reduces the digital footprint of the multimedia content. In an embodiment, the disclosed method and system summarizes a lengthy instructional video using a combination of audio, video, and possibly textual cues.

The present disclosure may be realized in hardware, or in a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skill in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for creating a summarized multimedia content, the method comprising:
extracting, by one or more processors, one or more frames from a plurality of frames in a multimedia content, based on a measure of area occupied by a text content in a portion of each of the plurality of frames;
selecting, by the one or more processors, one or more sentences from an audio content associated with the multimedia content based on at least a weight associated with a plurality of words in a plurality of sentences present in the audio content;
extracting, by the one or more processors, one or more audio segments from the audio content associated with the multimedia content based on one or more parameters associated with the audio content; and
creating, by the one or more processors, the summarized multimedia content based on the one or more frames, the one or more sentences, and the one or more audio segments.

2. The method of claim 1, wherein the portion corresponds to an area where the text content is displayed in the plurality of frames, wherein the area corresponds to at least one of a blackboard, a whiteboard, a paper, and/or a projection screen.

3. The method of claim 2, wherein the area occupied by the text content in the portion is determined based on a mean-shift segmentation technique.

4. The method of claim 1, wherein the one or more parameters comprise an intensity of a speaker in the audio content, a speaking rate of the speaker in the audio content, a prosodic pattern of the speaker in the audio content, an accent of the speaker in the audio content, and an emotion of the speaker in the audio content.

5. The method of claim 1, further comprising creating, by the one or more processors, a histogram associated with each frame of the plurality of frames based on a number of pixels representing the text content in the portion.

6. The method of claim 1, further comprising removing, by the one or more processors, one or more redundant frames from the one or more frames based on one or more image processing techniques.

7. The method of claim 6, wherein the one or more image processing techniques comprise Scale-Invariant Feature Transform (SIFT), and Fast Library for Approximate Nearest Neighbors (FLANN).

8. The method of claim 1, wherein the multimedia content corresponds to a video file.

9. The method of claim 1, wherein the summarized multimedia content has a pre-defined storage size, and a pre-defined playback duration.

10. The method of claim 9, further comprising receiving an input, by the one or more processors, corresponding to the pre-defined playback duration, and the pre-defined storage size associated with the summarized multimedia content from a user.

11. The method of claim 9, wherein the one or more sentences to be included in the summarized multimedia content are selected based on a greedy selection from the one or more sentences until the pre-defined storage size and the pre-defined playback duration are satisfied.

12. The method of claim 1, further comprising assigning, by the one or more processors a first rank to each of the one or more sentences based on the weight.

13. The method of claim 1, wherein the one or more sentences are selected from the audio content based on a graph, wherein the graph comprises a plurality of nodes and a plurality of edges, wherein each of the plurality of nodes correspond to each of the plurality of sentences in the audio content and each of the plurality of edges correspond to a similarity between the plurality of sentences.

14. The method of claim 13, wherein the similarity between the plurality of sentences is determined based on the weight, wherein the weight is obtained from bag of words representation of the plurality of words.

15. A multimedia content server to create a summarized multimedia content, the multimedia content server comprising:
one or more processors configured to:
extract one or more frames from a plurality of frames in a multimedia content, based on a measure of area occupied by a text content in a portion of each of the plurality of frames;
select one or more sentences from an audio content associated with the multimedia content based on at least a weight associated with a plurality of words in a plurality of sentences present in the audio content;
extract one or more audio segments from the audio content associated with the multimedia content based on one or more parameters associated with the audio content; and
create the summarized multimedia content based on the one or more frames, the one or more sentences, and the one or more audio segments.

16. The multimedia content server of claim 15, wherein the portion corresponds to an area where the text content is displayed in the plurality of frames, wherein the area corresponds to at least one of a blackboard, a whiteboard, a paper, and/or a projection screen.

17. The multimedia content server of claim 15, wherein the one or more parameters comprise an intensity of a speaker in the audio content, a speaking rate of the speaker in the audio content, a prosodic pattern of the speaker in the audio content, an accent of the speaker in the audio content, and an emotion of the speaker in the audio content.

18. The multimedia content server of claim 15, wherein the one or more processors are configured to create a histogram associated with each frame of the plurality of frames based on a number of pixels representing the text content in the portion.

19. The multimedia content server of claim 15, wherein the one or more processors are configured to remove one or more redundant frames from the one or more frames based on one or more image processing techniques.

20. The multimedia content server of claim 15, wherein the summarized multimedia content has a pre-defined storage size, and a pre-defined playback duration.

21. A non-transitory computer-readable storage medium having stored thereon, a set of computer-executable instructions for causing a computer comprising one or more processors to perform steps comprising:
extracting, by one or more processors, one or more frames from a plurality of frames in a multimedia content, based on a measure of area occupied by a text content in a portion of each of the plurality of frames;
selecting, by the one or more processors, one or more sentences from an audio content associated with the multimedia content based on at least a weight associated with a plurality of words in a plurality of sentences present in the audio content;
extracting, by the one or more processors, one or more audio segments from the audio content associated with the multimedia content based on one or more parameters associated with the audio content; and
creating, by the one or more processors, a summarized multimedia content based on the one or more frames, the one or more sentences, and the one or more audio segments.
